(19) United States
(12) Patent Application Publication
(10) Pub. No.: US 2010/0086840 A1
(43) Pub. Date: Apr. 8, 2010

(54) BATTERY LATCHING MECHANISM

(75) Inventor: GANG SHAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/570,108

(22) Filed: Sep. 30, 2009

(30) Foreign Application Priority Data
Oct. 6, 2008 (CN) 200810304754.0

(51) Int. Cl. H01M 2/10

(52) U.S. Cl. 429/97

(57) ABSTRACT

A battery latching mechanism for securing a battery includes a resisting block, at least one elastic member, and a lower body section. The lower body section comprises two latch arms. The battery is received in the lower body section and latched between the two latch arms. The resisting block is slidably received in the lower body section. when the resisting block is slid relative to the lower body section to move apart the latch arms, the battery is released from between the latch arms, and ejected out of the lower body section compressed by the elastic member.

### BACKGROUND

1. Technical Field

The present disclosure relates to battery latching mechanisms and, particularly, to a battery latching mechanism used in a portable electronic device.

2. Description of Related Art

Battery latching mechanisms are usually provided to secure batteries within portable electronic devices.

As the demand for multifunctional portable electronic devices rises, batteries of portable electronic devices are desired to be more powerful to satisfy high demands of users. However, most powerful batteries are usually large and heavy, thus strong latch mechanisms are required to secure these large, heavy batteries.

To change the battery for recharging, the operator must first release the latching mechanism and then separate the battery from the portable electronic device. Thus it is inconvenient and time consuming to replace the battery.

Therefore, there is room for improvement within the art.

### BRIEF DESCRIPTION OF THE DRAWINGS

Many aspects of the battery latching mechanism can be better understood with reference to the following drawings. These drawings are not necessarily drawn to scale, the emphasis instead being placed upon clearly illustrating the principles of the present battery latching mechanism. Moreover, in the drawings like reference numerals designate corresponding sections throughout the several views.

FIG. 1 is an isometric, assembled view of the battery latching mechanism, according to an exemplary embodiment.

FIG. 2 is an exploded, isometric view of a battery latching mechanism shown in FIG. 1.

FIG. 3 is similar to FIG. 1, but with the upper body section partially omitted.

FIG. 4 is a schematic view of the battery latching mechanism shown in FIG. 3, with the battery received in the receiving space.

FIG. 5 is similar to FIG. 4, but showing the battery partially ejected out of the receiving space.

### DETAILED DESCRIPTION

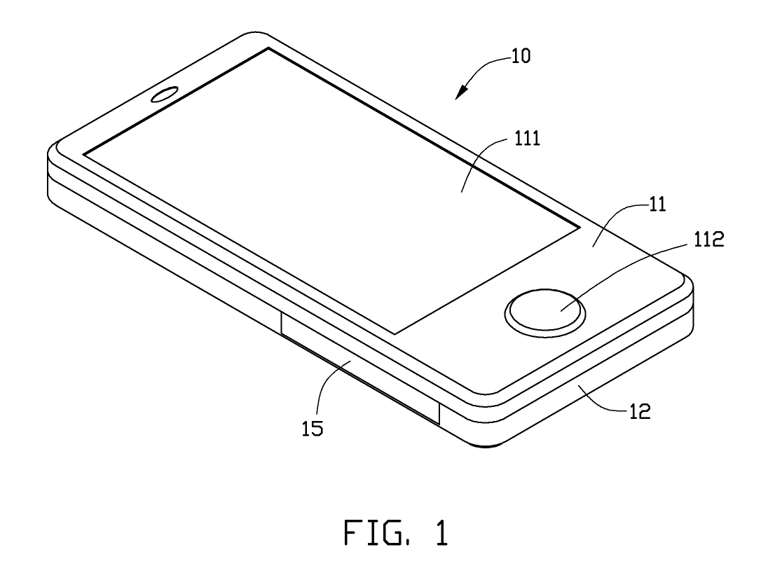

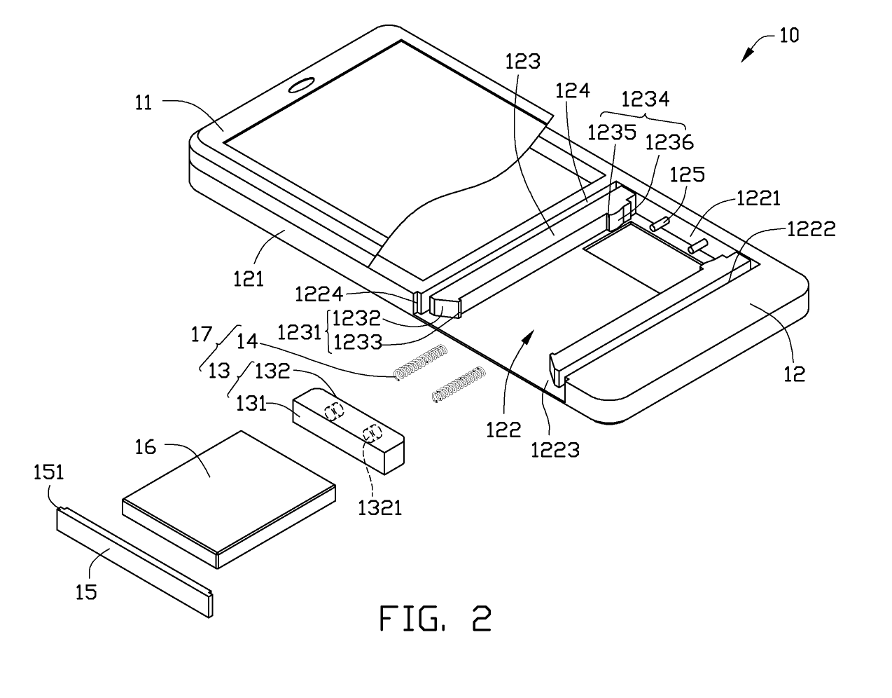

FIGS. 1 and 2 show an exemplary battery latching mechanism 10. The battery latching mechanism 10 is fit for securing a battery 16, and includes an upper body section 11, a lower body section 12, an eject mechanism 17, and a battery cover 15. The eject mechanism 17 includes a resisting block 13 and at least one elastic member 14. The upper body section 11 is attached to the lower body section 12 to form a housing of a portable electronic device. The battery 16 is received in the lower body section 12, and covered by the battery cover 15. The resisting block 13 is slidably received in the lower body section 12 and can eject the battery 16 out of the lower body section 12. The elastic members 14 are located between the resisting block 13 and the lower body section 12.

The upper body section 11 includes a screen 111 and a keypad 112. The upper body section 11 is used to cover the lower body section 12. The lower body section 12 is similar to the upper body section 11 in shape. The lower body section 12 includes a peripheral wall 121. The lower body section 12 further defines a receiving space 122. The receiving space 122 is surrounded by a bottom wall 1221 and two sidewalls 1222, forming an opening 1223 through the peripheral wall 121 opposite to the bottom wall 1221. The two sidewalls 1222 are opposite to each other, and vertically connect with the bottom wall 1221. The opening 1223 provides an entry for the battery 16 into the receiving space 122. Each sidewall 1222 defines a notch 1224 adjacent to the opening 1223, used to latch the battery cover 16. Two moveable latch arms 123 spacedly protrude from the bottom wall 1221 towards the opening 1223. Each latch arm 123 extends along the sidewalls 1222. An aperture 124 is defined between each latch arm 123 and one corresponding sidewall 1222 to facilitate deformation of the latch arm 123. A clamp 1231 protrudes from each latch arm 123 adjacent to the opening 1223. Each clamp 1231 includes a guiding surface 1232 and a latch surface 1233 adjacent to the guiding surface 1232. The guiding surface 1232 is a slope, used to guide the battery 16 into the receiving space 122. The latch surface 1233 abuts against the battery 16 to latch the battery 16 in the receiving space 122. A projection 1234 protrudes from each latch arm 123 towards the other latch arm 123. Each projection 1234 includes a clamping surface 1235 and a resisting surface 1236 connected to the clamping surface 1235. The clamping surface 1235 faces the opening 1223. The clamping surfaces 1235 and the latch surfaces 1233 latch the battery 16 therebetween. The resisting surfaces 1236 face each other and are configured for being deflected by the resisting block 13. A plurality of poles 125 protrude from the bottom wall 1221 towards the opening 1223. The poles 125 are located between the two latch arms 123, corresponding to the elastic members 14. Each elastic member 14 is engaged with and coiled around one of the poles 125.

The resisting block 13 includes a resisting wall 131 and a mounting wall 132 opposite to the resisting wall 131. The mounting wall 132 defines a plurality of holes 1321, corresponding to the poles 125. Each hole 1321 receives one pole 125 and one elastic member 14 therein. The resisting wall 131 is used to resist the battery 16.

Each elastic member 14 is a compressible spring. One end of the elastic member 14 is fastened to the bottom wall 1221, the other end is received in the hole 1321 and fastened to the resisting block 13.

The battery cover 15 has the same size and shape as the opening 1223 to exactly close off the opening 1223. A latch block 151 protrudes from each side of the battery cover 15, corresponding to the notch 1224. Each latch block 151 latch with the notch 1224, thus assembling the battery cover 15 to the lower body section 12.

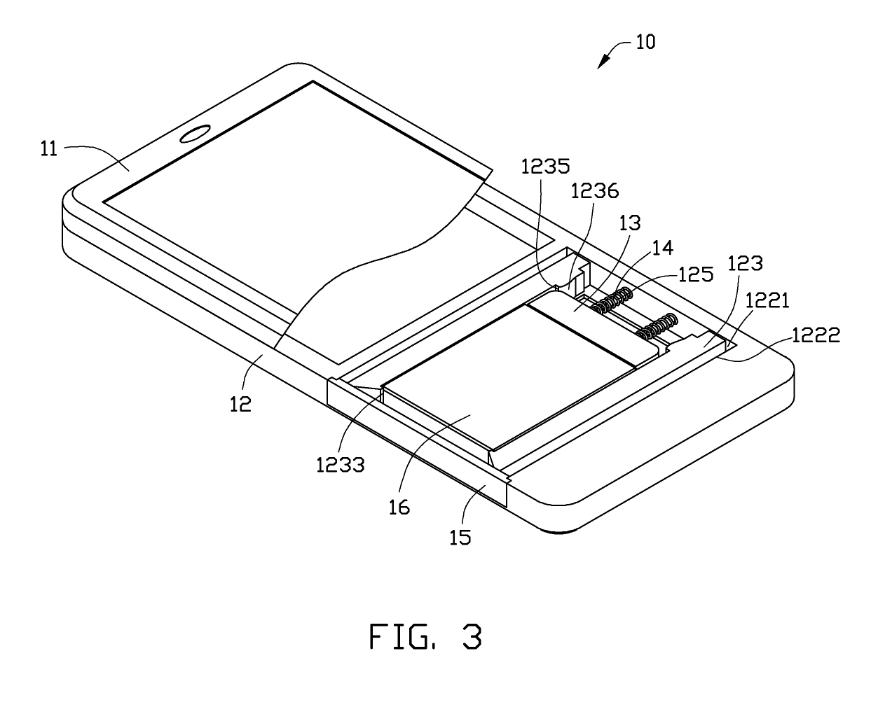

Referring to FIGS. 2 and 3 together, each elastic member 14 is coiled about and engaged with one pole 125, with one end of the elastic member 14 resisting against the bottom wall 1221. The resisting block 13 is received in the receiving space 122, with the other end of the elastic member 14 received in the hole 1321 and secured to the resisting block 13.

Referring to FIGS. 2 and 3 again, the battery 16 is inserted into the receiving space 122. During this stage, the battery 16 deflects the two latch arms 123, guided by the guiding surfaces 1232 until the battery 16 goes over the clamp 1231 to be latched between the stopping surfaces 1233 and the clamping surfaces 1235. At this time, the elastic members 14 are compressed as the resisting block 13 slides towards the bottom wall 1221 and accumulates an elastic force against the battery 16. Finally the battery cover 15 is covered to the opening 1223.

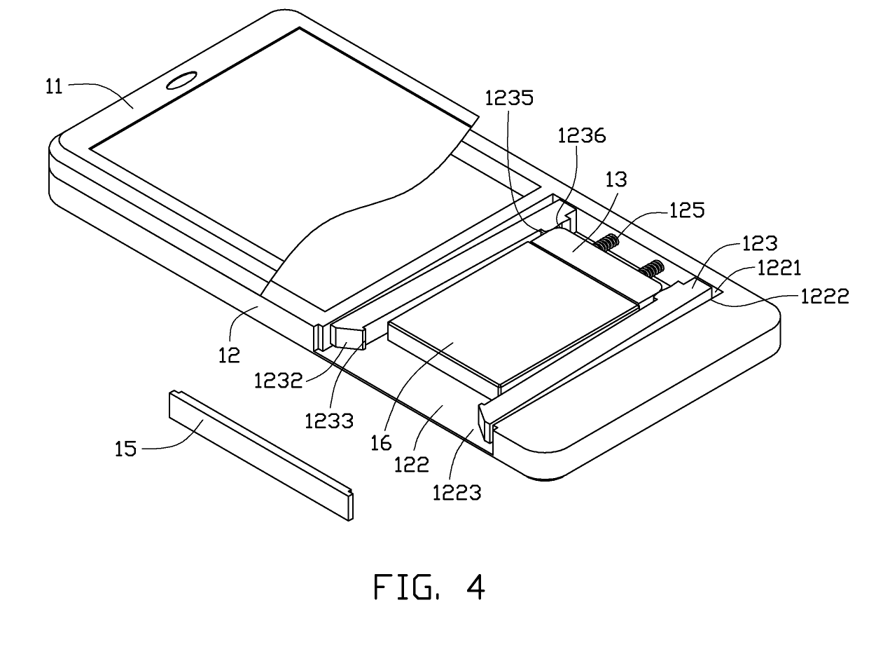

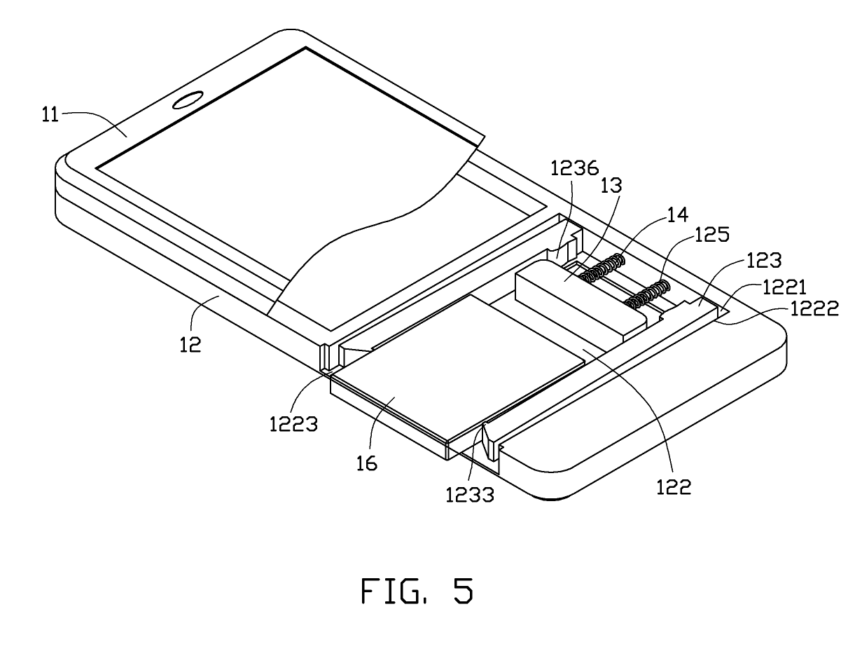

Referring to FIGS. 4 and 5, to remove the battery 16 from the receiving space 122, the battery cover 15 is detached from the opening 1233. Then an external force is exerted on the battery 16 to push the battery 16 towards the bottom wall 1221. During this process, the battery 16 resists the two resisting surfaces 1236 to deflect the two projections 1234 away from each other. Thus, the two latch arms 123 biases away from each other to make the two clamps 1231 open. At this time, the battery 16 is ejected by the elastic members 14 partially out of the opening 1223. Now it's easy for a user to remove the battery 16.

The battery latching mechanism 10 uses the two latch arms 123 to latch the battery 16, and uses the resisting block 13 and the elastic members 14 to eject the battery 16. Therefore, Thus it is convenient and easy to replace the battery.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A battery latching mechanism for securing a battery, comprising:
a resisting block;
at least one elastic member; and
a lower body section comprising two moveable latch arms for latching the battery therebetween, the resisting block being slidably received in the lower body section;
wherein the resisting block is slid relative to the lower body section to move apart the latch arms, the battery is released from between the latch arms, and ejected out of the lower body section under the force of the elastic member.

2. The battery latching mechanism as claimed in claim 1, wherein the lower body section defines a receiving space used to receive the battery therein.

3. The battery latching mechanism as claimed in claim 2, wherein the receiving space is surrounded by a bottom wall and two sidewalls, forming an opening through a peripheral wall of the lower body section, the opening is opposite to the bottom wall, the two sidewalls are opposite to each other, and vertically connect with the bottom wall, the opening provides an entry for the battery into the receiving space.

4. The battery latching mechanism as claimed in claim 3, wherein the two latch arms spacingly protrude from the bottom wall towards the opening, an aperture is defined between each latch arm and one corresponding sidewall to provide movement space for the latch arm.

5. The battery latching mechanism as claimed in claim 3, wherein a clamp protrudes from each latch arm adjacent to the opening, used to latch the battery in the receiving space.

6. The battery latching mechanism as claimed in claim 5, wherein each clamp includes a guiding surface and a latch surface opposite to the guiding surface, the guiding surface issued to guide the battery to the receiving space, the latch surface abuts against the battery to latch the battery in the receiving space.

7. The battery latching mechanism as claimed in claim 6, wherein a projection protrudes from each latch arm towards the other latch arm, the resisting block resists the two projections to move the two latch arms to release the battery from the two latch arms.

8. The battery latching mechanism as claimed in claim 7, wherein each projection includes a clamping surface and a resisting surface connected to the clamping surface, the clamping surface faces the opening, the clamping surfaces and the latch surfaces latch the battery therebetween, the resisting surface faces the sidewall and is configured for being resisted by the resisting block.

9. The battery latching mechanism as claimed in claim 3, wherein at least one pole protrudes from the bottom wall towards the opening, corresponding to the elastic member, the elastic member is coiled around the pole.

10. The battery latching mechanism as claimed in claim 9, wherein the resisting block includes a resisting wall and a mounting wall opposite to the resisting wall, the mounting wall defines at least one hole, corresponding to the pole, each hole receives one pole and one elastic member therein, the resisting wall is used to resist the battery.

11. The battery latching mechanism as claimed in claim 3, further comprising a battery cover, wherein the battery cover is configured for covering the opening.

12. The battery latching mechanism as claimed in claim 11, wherein a latch block protrudes from each side of the battery cover, a notch is defined in each sidewall adjacent to the opening, each latch block latches with the notch.

13. A battery latching mechanism for securing a battery, comprising:
a lower body section comprising two moveable latch arms for latching the battery therebetween, and
an eject mechanism mounted on the lower body section;
wherein when the eject mechanism being configured for moving apart the latch arms to release the battery from between the latch arms and eject the battery out of the lower body section.

14. The battery latching mechanism as claimed in claim 13, wherein the eject mechanism 17 comprises a resisting block and at least one elastic member resisted between the lower body section and the resisting block, the resisting block is slidably received in the lower body section and configured to move apart the latch arms to make the battery released from between the latch arms.

15. The battery latching mechanism as claimed in claim 13, wherein the lower body section defines a receiving space used to receive the battery therein, the two latch arms are defined in the receiving space.

16. The battery latching mechanism as claimed in claim 15, wherein the receiving space is surrounded by a bottom wall and two sidewalls, forming an opening through a peripheral wall of the lower body section, the opening is opposite to the bottom wall, the two sidewalls are opposite to each other, and vertically connect with the bottom wall, the opening provides an entry for the battery into the receiving space.

17. The battery latching mechanism as claimed in claim 15, wherein the two latch arms spacingly protrude from the bottom wall towards the opening, an aperture is defined between each latch arm and one corresponding sidewall to facilitate movement of the latch arm.

18. The battery latching mechanism as claimed in claim 15, wherein a clamp protrudes from each latch arm adjacent to the opening, used to latch the battery in the receiving space.
